(19) United States
(12) Patent Application Publication
(10) Pub. No.: US 2025/0170807 A1
(43) Pub. Date: May 29, 2025

(54) Environmentally Sustainable Flooring Product Comprising Natural Fibers and Bio-Based Resins

(71) Applicant: Joseph E. Luttwak, Mill Valley, CA (US)

(72) Inventor: Joseph E. Luttwak, Mill Valley, CA (US)

(73) Assignee: Lingrove Inc., San Francisco, CA (US)

(21) Appl. No.: 18/900,104

(22) Filed: Sep. 27, 2024

Related U.S. Application Data
(60) Provisional application No. 63/541,683, filed on Sep. 29, 2023.

(51) Int. Cl. B32B 27/12; B32B 3/06; B32B 5/02; B32B 21/02; B32B 21/08; B32B 23/08; E04F 15/02; E04F 15/10; E04F 15/16

(52) U.S. Cl. CPC B32B 27/12; B32B 3/06; B32B 5/02; B32B 21/02; B32B 21/08; B32B 23/08; E04F 15/02038; E04F 15/107; E04F 15/163; B32B 2262/06; B32B 2307/102; B32B 2307/546; B32B 2307/558; B32B 2307/56; B32B 2307/7376; B32B 2419/04; B32B 2451/00; B32B 2607/00

(57) ABSTRACT

A flooring product with improved durability, environmental sustainability, and cost competitiveness may include a plurality of layers. The plurality of layers may be structured in various orders, or layups. Each layer of the plurality of layers may have a specific thickness, weight/areal density, and/or other features, such as orientation, relative to one or more of the other layers.

### RELATED APPLICATION DATA

This application claims priority to U.S. Application No. 63/541,683 filed on Sep. 29, 2023, which is incorporated fully herein by reference for all non-limiting purposes. This application relates to U.S. application Ser. No. 16/872,293 filed on May 11, 2020, now U.S. Pat. No. 11,752,737, which claims priority to U.S. Application No. 62/865,112 filed on Jun. 21, 2019, and is a continuation-in-part application of U.S. application Ser. No. 15/788,767 filed on Oct. 19, 2017, which claims priority to U.S. Application No. 62/446,809 filed on Jan. 16, 2017, and is a continuation-in-part application of U.S. application Ser. No. 14/546,518 filed on Nov. 18, 2014, now U.S. Pat. No. 9,818,380, which claims priority to U.S. Application No. 61/905,572 filed on Nov. 18, 2013. This application also relates to U.S. application Ser. No. 18/068,606 filed on Dec. 20, 2022. Each of the above applications are incorporated herein by reference in their entirety for all non-limiting purposes.

### FIELD

Aspects described herein generally relate to flooring products comprised of bio-based materials. More specifically, aspects relate to resilient and sustainable products for applying to a floor, such as a subfloor, wherein the flooring products comprise a plurality of layers. The plurality of layers may be structured in various orders and may comprise natural fibers, bio-based resins, and/or other bio-based and/or recycled content. Flooring products according to aspects described herein provide advantageous qualities, such as environmental sustainability due to, for example, decreased use of wood; increased air quality in the place of installation due to, for example, decreased use of carcinogenic chemicals; ease of installation; cost competitiveness; durability, such as impact, moisture, and/or scratch resistance and static load capacity; soundproofing; the ability to remain flat; and aesthetic appeal. Aspects further relate to methods of manufacture of flooring products, including products comprising layers described herein.

### BACKGROUND

Many flooring products comprise wood from trees, including to add stability to the flooring product and/or increase aesthetic appeal. The use of certain woods can be disadvantageous. For example, the use of certain woods may increase deforestation and may be problematic from a carbon footprint perspective.

Flooring products may also comprise plastics, which can also be disadvantageous. For example, certain plastics comprise volatile organic compounds (VOCs), may be carcinogenic and/or subject to regulation, and may be problematic from an indoor air quality perspective.

Flooring products may also comprise other materials, including, for example, stone, that can have drawbacks, such as high cost and difficulty in installation. Additional flooring products may have layers dedicated to providing certain qualities, such as an additional, standalone stability layer, that can have drawbacks, such as adding cost and/or complexity to the manufacturing process and increasing the height of the flooring product.

### SUMMARY

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

Aspects of this disclosure are directed to bio-based flooring products having increased performance abilities and other beneficial qualities, such as durability, sustainability, soundproofing, the ability to remain flat relative to a floor (e.g., subfloor) on which they are applied, cost competitiveness, and aesthetic appeal. More specifically, aspects of this disclosure are directed to bio-based composite resilient flooring products that comprise layers structured in various orders, including layers comprising agricultural waste (e.g., flax), resins, cellulosic, cork, rubber, and/or various foams. Aspects of this disclosure are also directed to bio-based flooring products that do not have a built-in stability layer but provide durability and resiliency properties comparable to other flooring products comprising an additional stability layer. Further aspects of this disclosure are directed to manufacture of flooring products, including processes for producing flooring products comprising layers described herein and processes that solve global-warming-related issues associated with certain flooring products that include certain types of layers. For example, among other advantages, the lack of an additional stability layer according to certain embodiments disclosed herein equates to less material needed in manufacturing and reduced product global warming potential. It is unexpected that a bio-based flooring product, including, for example, one without an additional built-in stability layer, can achieve certain performance characteristics. Bio-based materials have been typically avoided and have been regarded as inadequate mechanically. However, the examples discussed herein have overcome these deficiencies despite being bio-based.

### BRIEF DESCRIPTION OF THE DRAWINGS

A more complete understanding of the present disclosure and certain advantages thereof may be acquired by referring to the following detailed description in consideration with the accompanying drawings, in which like reference numbers indicate like features, and wherein:

FIG. 1 illustrates a cross-sectional view of an exemplary flooring product according to one or more aspects of the disclosure;

FIG. 2 illustrates a cross-sectional view of an exemplary flooring product according to one or more aspects of the disclosure;

FIG. 3 illustrates a cross-sectional view of an exemplary flooring product according to one or more aspects of the disclosure;

FIG. 4 illustrates a cross-sectional view of an exemplary flooring product according to one or more aspects of the disclosure; and

FIGS. 5A-5B illustrate annotated, cross-sectional views of exemplary click lock flooring products with a tongue and groove connection.

### DETAILED DESCRIPTION

In the following description of the various embodiments, reference is made to the accompanying drawings, which form a part hereof, and in which is shown by way of illustration various embodiments in which aspects described herein may be practiced. It is to be understood that other embodiments may be utilized and structural and functional modifications may be made without departing from the scope of the described aspects and embodiments. Aspects described herein are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

Also, while the terms “top,” “middle,” “bottom,” and the like may be used in this specification to describe various example features and elements of the disclosure, these terms are used herein as a matter of convenience, e.g., based on the example orientations shown in the figures or the orientation during typical use. Additionally, the term “plurality,” as used herein, indicates any number greater than one, either disjunctively or conjunctively, as necessary, up to an infinite number. Nothing in this specification should be construed as requiring a specific three dimensional orientation of structures in order to fall within the scope of this disclosure. Also, the reader is advised that the attached drawings are not necessarily drawn to scale.

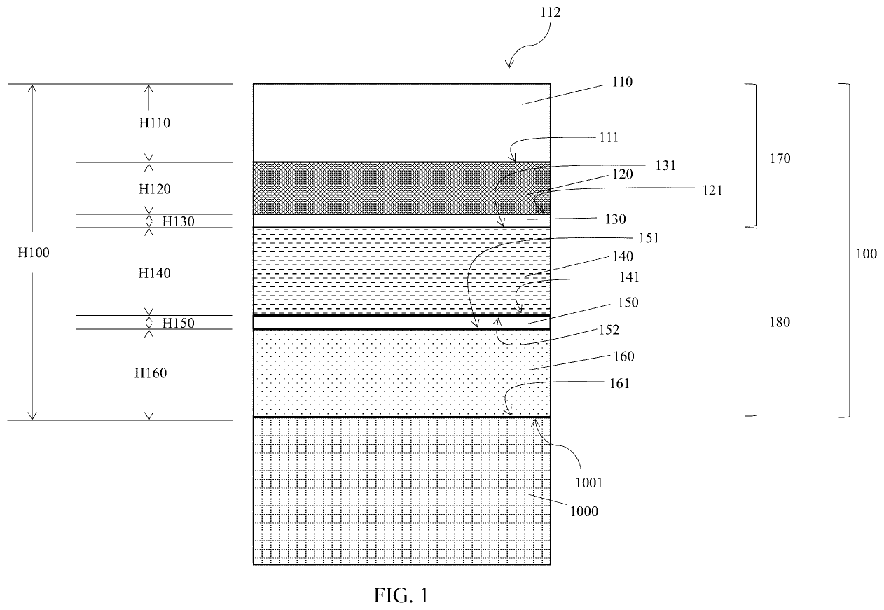

FIGS. 1-4 illustrate cross-sectional views of various flooring products configured to be applied to a floor, such as a subfloor. The flooring products described herein can be applied in a number of ways. For example, and without limitation, the flooring product may be rolled and transported to a site for installation. The flooring product may be unrolled at the installation site and cut into sheets, and the sheets may be attached (e.g., by nailing or bonding with adhesive) to a subfloor. The flooring product may also be taped down with carpet tape such as offered by Shurtape Technologies LLC of Hickory, NC. This enables easier installation than with wood planks but with a similar natural grain finish. The flooring product may also just be rolled flat without any tape, adhesive, or glue as a quick installation. The ability to roll the flooring product according to this example may, among other things, ease transportation and installation. These rolls may be wider than conventional wood flooring made into planks and allow for large format and effectively seamless installations. In another example, the flooring product may be mounted to a flexible or rigid substrate, such that the flooring product is in the form of tiles. The tiles can be manufactured in various shapes and sizes and can be installed by interlocking or adhering to a floor surface. Tiles also may be butt jointed. In one other example, the flooring product may be in the form of other flooring types, such as planks or panels made from natural fibers and bio-based resins mounted to a rigid substrate. These flooring types can be installed using conventional methods, such as nailing or bonding with adhesive to a floor, such as a subfloor. In yet another example, the flooring product may be click lock flooring and include a tongue and groove connection and may be installed using methods known to those skilled in the art.

As shown in FIGS. 1-4, the flooring product may include a plurality of layers. The order in which the layers are structured, sometimes referred to as the layup of the layers, may vary, for example, based on the desired properties and/or dimensions of the flooring product. Further, each layer included in the plurality of layers may vary in thickness, weight/areal density, and/or other features relative to the other layers. The examples discussed herein can be used as a platform allowing for a greater flexibility in specifications, including aesthetics, thickness, and translucency with low carbon inputs.

FIG. 1 illustrates one embodiment of a flooring product 100 according to the present disclosure. Flooring product 100 may be a sheet type backed flooring that is flexible and able to be rolled for ease of installation. As shown in FIG. 1, the plurality of layers includes a first resin layer 110 followed by a sheet 120 formed of natural fibers (where the fibers are optionally from agricultural waste), a second resin layer 130, a cellulosic layer 140, a third resin layer 150, and a backing layer 160. Together, the first resin layer 110, sheet 120, and second resin layer 130 may form a surface layer 170. Layers 110, 120, 130 may be responsible for both the flooring product 100 aesthetic and the environmental/mechanical resistance. Due to the material design and interaction between the layers, each layer serves multiple purposes reducing overall material needs using a novel approach. Also, together, the cellulosic layer 140, third resin layer 150, and backing layer 160 may form a substrate layer 180. Further, the third resin layer 150 may function as an adhesive layer, whereas the first resin layer 110 and second resin layer 130 may provide protection to the flooring product 100.

The first resin layer 110, the second resin layer 130, and the third resin layer 150 may be comprised of a thermoplastic resin, such as polylactic acid (PLA), polypropylene (PP), polyethylene terephthalate (PET), polyethylene terephthalate glycol (PET-G), acrylic (PMMA), polyurethane (PU), Thermoplastic urethane (TPU), Bio thermoplastic urethane (bioTPU), polyethylene (PE), polyethylene furanoate (PEF), high-density polyethylene (HDPE), ultra-high-molecular-weight polyethylene (UHMWPE), low-density polyethylene (LDPE), polyhydroxyalkanoates (PHA), polybutylene succinate (PBS), polycarbonate (PC), and/or polyamide (PA), and/or may be comprised of a bio-based resin, including relevant resins above and those derived from plants, such as corn, cassava, sugar, molasses, soy, cellulose, and/or switchgrass. The second resin layer 130 and the third resin layer 150 may additionally be comprised of biaxially oriented polylactic acid (BOPLA). The third resin layer 150 may additionally be comprised of a polyamide. In one example, the first resin layer 110, the second resin layer 130, and the third resin layer 150 may all be comprised of PLA. The first resin layer 110, the second resin layer 130, and the third resin layer 150 may be oriented, such as biaxially, or may be non-oriented.

As discussed above, the sheet 120 may be formed of natural fibers, such as flax, covercress stalk, shives, hurd, soybean meal, grape vines, corn husks, mulch, general vegetable stalk, general vegetable husk, general organic matter, and/or wood fiber along with other natural fibers having similar properties. The sheet 120 may optionally be formed from agricultural waste such that it is an agricultural waste layer. The cellulosic layer 140 may be comprised of cellulose, cellulosicboard, and/or other cellulosic materials known to those skilled in the art. The adhesive nature of the resins integrated into the flooring product 100 in the resin layers allows for multiple different types of backing layers 160. The backing layer 160 may be comprised of materials, such as various types of rubber (including nitrile rubber, natural gum rubber, styrene-butadiene rubber, and recycled sheet rubber), polyvinyl chloride (PVC), polypropylene (PP), cork, rubberized cork, various foams, polystyrene, cork/silicone blends, felt, and/or jute along with materials having similar properties to the materials listed above. The backing layer 160 may also be comprised of materials that act as a sound barrier. These backing layers 160 add benefits to performance, installation, and/or circularity without compromising the aesthetic of the flooring product 100. In one example, the first resin layer 110, the second resin layer 130, and the third resin layer 150 are all comprised of PLA, the sheet or agricultural waste layer 120 is comprised of flax, the cellulosic layer 140 is comprised of cellulosic material, and the backing layer 160 is comprised of rubber.

The layers may be flexible, including the backing layer 160, to allow for the flooring product 100 to be rolled. Rollability of the flooring product 100 may assist with transportability and installation of the flooring product 100 as described above.

In some embodiments, such as the one shown in FIG. 1, the backing layer 160 may be the innermost layer from the floor 1000. The backing layer 160 may have an inner surface 161. In some embodiments, the inner surface 161 of the backing layer 160 may be configured to be applied to and abut the floor surface 1001. In other embodiments, a film (not shown) may be applied to the inner surface 161, and can be for example, in the form of a release layer, such that the release layer or film abuts the floor surface 1001. The release layer or film can be silicone coated cellulosic material. The backing layer 150 may also have an outer surface 152. In one example, such as the one illustrated in FIG. 1, the first resin layer 110 may be the outermost layer from the floor 1000. In another example, the flooring product 100 may optionally include a top coat (not shown in FIG. 1) on top of the first resin layer 110 such that the top coat is the outermost layer from the floor 1000. The top coat may be, for example and without limitation, a bio-based finish such as those made of linseed oil as well as those made from polyurethane. The order, or layup, of the plurality of layers in the embodiment shown in FIG. 1 may advantageously allow for an outer surface 112 of the first resin layer 110 to be at a distance H100. In some embodiments, H100 may be substantially uniform at substantially all points along the floor surface 1001. In embodiments where the floor surface 1001 is substantially flat as shown in FIG. 1 (for example, where the floor 1000 is a flat subfloor), the outer surface 112 of the first resin layer 110 is also substantially flat and is thus substantially parallel to the floor surface 1001 where distance H100 is substantially uniform at substantially all points along the floor surface 1001. In other embodiments where the floor surface 1001 is not substantially flat (for example, where the floor 1000 is a sloped subfloor or where the floor is a set of stairs), the outer surface 112 of the first resin layer 110 substantially resembles the shape of the floor surface 1001 where distance H100 is substantially uniform at substantially all points along the floor surface 1001.

In another example, a texturing can be applied to the top layer (the first resin layer 110 in the embodiment illustrated in FIG. 1), which can include various levels of roughness or patterns that breaks up a uniform appearance of the material, including one or more of waves, ridges, channels, emboss, deboss, shapes, repeated abstract, representational and/or geometric motifs, etc. This may in certain examples reduce surface area and thus increase the scratch resistance of the flooring product 100. Such texturing can be applied to any of the examples discussed herein.

The thickness of each layer, the weight/areal density of each layer, and/or other features, such as orientation, of each layer of the embodiment shown in FIG. 1 may further increase desirable properties, such as resistance to impact, added stiffness, hardness, moisture, scratching, compressive strength, and/or abrasion, and allow for the overall flooring product 100 to meet certain specifications, such as specifications that require compliance with certain performance standards yet limit the overall height of the flooring product 100. Further, the density/weave of the fibers can provide a more structurally sound surface which disperses impact energy leading to greater resistance to impact and resistance to swelling. In one example the sheet or agricultural waste layer 120 may comprise multiple layers of natural fibers (not shown in FIG. 1) with various directionalities or orientations, such as layers that run 90 degrees relative to one another. Such characteristics may also allow for distance H100 to remain substantially uniform at substantially all points along the floor surface 1001, including in certain climates and/or environments, such as those with changing relative humidity and/or high relative humidity, those that involve a high degree of traffic (e.g., floors in a department store), and/or those employ heavy machinery. In this way, durability-related issues, such as warping, curling, discoloration, degradation, scratching, staining, abrasion, and/or cracking of the flooring product 100, are minimized. In one example, the second resin layer 130 may be configured to help to maintain distance H100 substantially uniform along the floor surface 1001.

For example, in one embodiment, the flooring product 100 may have a total thickness of approximately 2 mm to 6 mm, comprising a surface layer 170 and a substrate layer 180. The surface layer 170 may have a thickness of approximately 0.5 mm to 1.0 mm. The surface layer 170 may be comprised of the first resin layer 110, which may have a thickness H110 of approximately 6 mils to 12 mils, and in one particular example, may be about 9 mils, where one mil is one-thousandth of an inch, 0.001 inch., or 0.0254 mm (millimeter). In one embodiment, thickness H110 of the first resin layer 110 may be substantially uniform at all points throughout the flooring product 100. In another embodiment, thickness H110 of the first resin layer 110 may vary at different points throughout the flooring product 100. The surface layer 170 may also be comprised of the sheet or agricultural waste layer 120, which may have a thickness H120 of approximately 0.15 mm to 0.50 mm and may have a weight/areal density of approximately 50 GSM to 440 GSM, and in one example, about 105 GSM. In one embodiment, thickness H120 and weight/areal density of the sheet or agricultural waste layer 120 may be substantially uniform at all points throughout the flooring product 100. In another embodiment, thickness H120 and weight/areal density of the sheet or agricultural waste layer 120 may vary at different points throughout the flooring product 100. The surface layer 170 may also be comprised of the second resin layer 130, which may have a thickness H130 of approximately 1 to 5 mils. In one example, the first resin layer 110 thickness H110 and the second resin layer 130 thickness H130 can have a ratio of greater than 3 and in certain instances can be 1.2 to 8. In one particular example, the first resin layer 110 thickness H110 and the second resin layer 130 thickness H130 can have a ratio of 6. In one embodiment, thickness H130 of the second resin layer 130 may be substantially uniform at all points throughout the flooring product 100. In another embodiment, thickness H130 of the second resin layer 130 may vary at different points throughout the flooring product 100.

The substrate layer 180 may have a thickness of approximately 1.5 mm to 5 mm. The substrate layer 180 may be comprised of the cellulosic layer 140, which may have a thickness H140 of approximately 0.1 mm to 1 mm, and in one example, about 0.25 mm. In one embodiment, thickness H140 may be substantially uniform at all points throughout the flooring product 100. In another embodiment, thickness H140 may vary at different points throughout the flooring product 100. The substrate layer 180 may also be comprised of the third resin layer 150, which may have a thickness H150 of approximately 1 to 5 mils. In one example, the first resin layer 110 thickness H110 and the third resin layer 150 thickness H150 can have a ratio of greater than 3 and in certain instances can be 1.2 to 8. In one particular example, the first resin layer 110 thickness H110 and the third resin layer 150 thickness H150 can have a ratio of 6. In one example, the second resin layer 130 thickness H130 and the third resin layer 150 thickness H150 can have a ratio of greater than 0.75 and in certain instances can be 0.5 to 2. In one particular example, the second resin layer 130 thickness H130 and the third resin layer 150 thickness H150 can have a ratio of 1. In one embodiment, thickness H150 of the third resin layer 150 may be substantially uniform at all points throughout the flooring product 100. In another embodiment, thickness H150 of the third resin layer 150 may vary at different points throughout the flooring product 100. The substrate layer 180 may also be comprised of the backing layer 160, which may have a thickness H160 of approximately 1 mm to 3.5 mm, and in one example, about 3 mm. In one embodiment, thickness H160 of the backing layer 160 may be substantially uniform at all points throughout the flooring product 100. In another embodiment, thickness H160 of the backing layer 160 may vary at different points throughout the flooring product 100.

The distances from the floor surface 1001 to the inner surfaces 111, 121, 131, 141, 151, and 161 of each layer may be used to described the order, or layup, of the layers. For example, the distance from the inner surface 111 of the first resin layer 110 to the floor surface 1001 is greater than the distance from the inner surface 121 of the sheet or agricultural waste layer 120 to the floor surface 1001, which is greater than the distance from the inner surface 131 of the second resin layer 130 to the floor surface 1001, which is greater than the distance from the inner surface 141 of the cellulosic layer 140 to the floor surface 1001, and so on.

Among other desirable features, the embodiment of the flooring product 100 illustrated in FIG. 1 and described above is durable, for example, in terms of resistance to impact, moisture, soundproofing, and scratching. The durability-related qualities of the flooring product 100 illustrated in FIG. 1 are surprising and counterintuitive, including because the flooring product 100 does not comprise an additional, standalone stability layer yet exhibits comparable durability, including dimensional stability and static load capacity, to other flooring products that comprise such a stability layer, such as, for example, a glass fiber stability layer. The strength of the composite system created by the resin layers 110, 130, 150 and the sheet or agricultural waste layer 120, including where the resin layers 110, 130, 150 comprise a polymer such as PLA and the sheet or agricultural waste layer 120, which may include flax, provides stability without the need of an additional, standalone stability layer, which is unique. Yet it is contemplated that an additional stability layer could be used in conjunction with the examples discussed here. Additionally, the durability-related qualities of the flooring product 100 illustrated in FIG. 1 are also surprising and counterintuitive in view of the bio-based content and sustainability of the flooring product 100, described further below. As typical of unidirectional composite laminates, the natural fiber reinforced surface layer 110, 120, 130 adds considerable stiffness to the flooring product 100. The layers in the flooring product 100 may also lead to comparable soundproofing relative to other flooring products that comprise one or more layers dedicated to soundproofing. Further, the layers in the flooring product 100 may also provide favorable insulating and dampening qualities, including, for example, where the backing layer 160 comprises rubber. A compressible backing layer 160 such as rubber underlying the remaining layers of the flooring product 100 allows loads on the flooring product 100 to be spread while maintaining highly planar aspect.

Additional desirable features of the flooring product 100 illustrated in FIG. 1 include its environment sustainability and cost competitiveness. One factor contributing to these advantages is the decreased amount of material needed to make flooring product 100 relative to flooring products with comparable durability that include one or more stability layers. For example, the lack of a standalone, additional stability in flooring product 100 equates to less material needed in manufacturing, thereby lowering costs and reducing product global warming potential. Another factor contributing to environmental sustainability is the materials comprising flooring product 100. Bio-based materials comprising the flooring product 100 and the absence of wood, including wood sourced from endangered forests, in the flooring product 100 reduce the carbon footprint of the flooring product 100 relative to other flooring products and help mitigate deforestation. For example, the estimated global warming potential is about −0.128 kgCO2eq/kg for the example flooring product 100 in which the first resin layer 110, the second resin layer 130, and the third resin layer 150 are all comprised of PLA and the backing layer 160 is comprised of cork. Although the flooring product 100 avoids the use of wood, it retains an aesthetic appeal, including a wood-esque aesthetic property in some examples, that is comparable to the aesthetic appeal created in part by the wood used in other flooring products. In some examples, the flooring product 100 may have a natural grain aesthetic provided by natural fibers and resins comprising the flooring product 100, which is unique in a flexible flooring product 100 that is able to be rolled. Also, in some examples, certain layers of the flooring product 100 may be translucent. Also the use of translucent layers provides the adaptability of the flooring product such that color can be added to the various layers for aesthetic variations to mimic different woods, color match or create novel new finish; as well as one or more of embedded electronics, lights (e.g., LEDs), graphical user interfaces, etc., along with their associated power supplies in the form of wires and batteries may be implemented, as discussed in U.S. Pat. No. 11,752,737, which is fully incorporated herein by reference. Further, the seams are easily hidden in some embodiments of the flooring product 100, for example, because of the wood-esque aesthetic property of certain examples of the flooring product 100 and because two given sheets of certain examples of the flooring product 100 may not have the exact same pattern.

Another desirable feature of the flooring product 100 is the relative enhancement of the quality of the air surrounding the flooring product 100 after installation. Other flooring products often comprise chemicals, such as VOCs, that are designated as carcinogenic and can be detrimental to the surrounding air quality. The flooring product 100 and others described herein avoid the use of such chemicals, thereby improving air quality relative to other flooring products. In one example the amount of VOC of the flooring product 100 may be below 0.22 mg/m3 and may meet the VOC-related requirements of the FloorScore standard, which is incorporated herein fully by reference.

Further desirable features of the flooring product 100 include its ease of installation and ability to remain flat. Being comprised of materials that are flexible, unlike other flooring products, allows flooring product 100 to be rolled, for example, as it is transported to an installation site, and further increase the cuttability of the flooring product 100. The rollability of the flooring product 100 gives rise to many other benefits, such as the ability to increase the size of singular installation pieces of flooring product 100. For example, a rolled, single piece of the flooring product 100 according to certain aspects of this disclosure may be up to 200 meters long when unrolled. The layup of layers in flooring product 100 also contribute to the ability of the flooring product 100 to remain flat after installation and may integrate well with backing for easy installation by an installer. In addition, this can offer a seamless natural grain aesthetic which is not achievable with planks of wood.

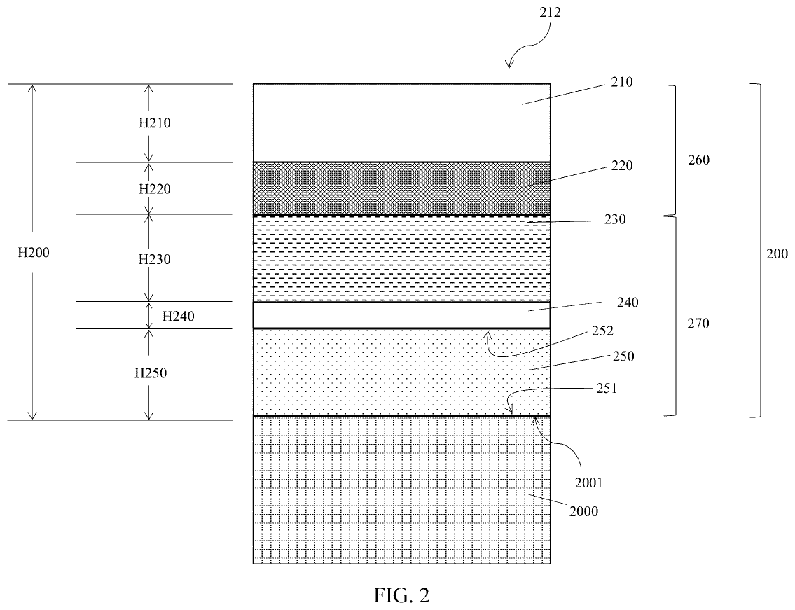

Other examples comprising layers in a different order, or layup, layers with different thicknesses, layers with different weights/areal densities, and/or layers with different features, such as orientation are also contemplated and may provide similar benefits. For example, FIG. 2 illustrates an alternative embodiment of a flooring product 200 where the plurality of layers includes a first resin layer 210 followed by a sheet or an agricultural waste layer 220, a cellulosic layer 230, a second resin layer 240, and a backing layer 250, which may include the same or similar materials as described in relation to the corresponding layers of FIG. 1 above. Together, the first resin layer 210 and sheet or agricultural waste layer 220 may form a surface layer 260. Also, together, the cellulosic layer 230, second resin layer 240, and backing layer 250 may form a substrate layer 270. Like flooring product 100, flooring product 200 may also be a sheet type backed flooring that is flexible and able to be rolled. The thicknesses and/or weights/areal densities of the first resin layer 210, the sheet or agricultural waste layer 220, the cellulosic layer 230, and the backing layer 250 may be similar to those described for the first resin layer 110, the sheet or agricultural waste layer 120, the cellulosic layer 140, and the backing layer 160 of FIG. 1 above. The second resin layer 240 may have a thickness H240 of approximately 1 to 5 mils. In one example, the first resin layer 210 thickness H210 and the second resin layer 240 thickness H240 can have a ratio of greater than 2 and in certain instances can be 1.2 to 8. In one particular example, the first resin layer 210 thickness H210 and the second resin layer 240 thickness H240 can have a ratio of 3. Thus, flooring product 200 may have a total thickness of approximately 1.5 mm to 5 mm.

In certain examples, such as the example shown in FIG. 2, the backing layer 250 may be the innermost layer from the floor 2000. The backing layer 250 may have an inner surface 251 configured to be applied to and abut a floor surface 2001. In other examples, and as described for flooring product 100 above, a film (not shown) may be applied to the inner surface 251 such that the film abuts the floor surface 2001. The backing layer 250 may also have an outer surface 252. Similar to the embodiment illustrated in FIG. 1, the embodiment of the flooring product 200 illustrated in FIG. 2 may advantageously allow for an outer surface 212 of the first resin layer 210 (i.e., the outermost layer from the floor 2000) to be at a distance H200 that is substantially uniform at substantially all points along the floor surface 2001. In this way, the outer surface 212 of the first resin layer 210 substantially resembles the shape of the floor surface 2001. In other examples, and as described for flooring product 100, a top coat (not shown) on top of the first resin layer 210 such that the top coat is the outermost layer from the floor 2000. The top coat of flooring product 200 may be, for example and without limitation, an added protective coating. The embodiment of the flooring product 200 illustrated in FIG. 2 may provide benefits comparable to those described for the flooring product 100 illustrated FIG. 1, such as durability, UV resistance, slip-resistance, scratch resistance, soundproofing, insulating, dampening, environment sustainability, cost competitiveness, aesthetic appeal, fire resistance, air-quality enhancement, flexibility, cuttability, and ability to remain flat after installation. It is also contemplated that other orders of layers, other materials, and/or other thicknesses discussed herein can be used to form the example flooring product layers in this example for optimization of the flooring product.

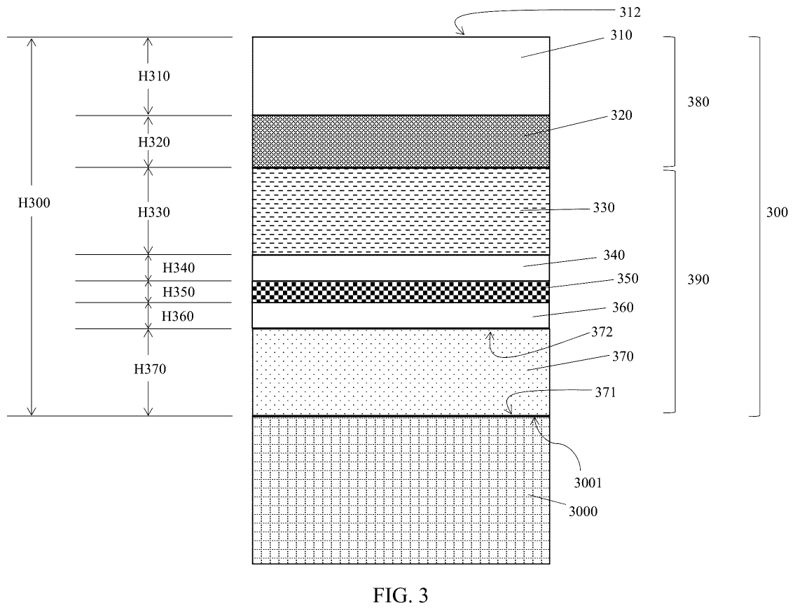

While flooring products 100, 200 exhibit beneficial durability and resiliency properties without a standalone, built-in stability layer, a separate stability layer and/or soundproofing layer may be included in some examples to further enhance the durability, resiliency, soundproofing, and similar qualities of the flooring product. One example of such a flooring product 300 is illustrated in FIG. 3. Flooring product 300 may be a resilient tile flooring. Flooring product 300 includes a first resin layer 310 followed by a sheet or an agricultural waste layer 320, a cellulosic layer 330, a second resin layer 340, a stability layer 350, a third resin layer 360, and a backing layer 370. Together, the first resin layer 310 and sheet or an agricultural waste layer 320 may form a surface layer 380. Also, together, the cellulosic layer 330, second resin layer 340, stability layer 350, third resin layer 360, and backing layer 370 may form a substrate layer 390. The first resin layer 310, sheet or agricultural waste layer 320, cellulosic layer 330, second resin layer 340, third resin layer 360, and backing layer 370 can be the same or similar materials as described in relation to the corresponding layers of FIG. 1 above. The stability layer 350 may be formed of tempered hardboard or other materials having similar properties. The thicknesses and/or weights/areal densities of the first resin layer 310, the sheet or agricultural waste layer 320, the cellulosic layer 330, and the backing layer 370 may be similar to those described for the first resin layer 110, the sheet or agricultural waste layer 120, the cellulosic layer 140, and the backing layer 160 of FIG. 1 above. The second resin layer 340 may have a thickness H340 of approximately 1 to 5 mils. The stability layer 350 may have a thickness H350 of approximately 59 mils (1.5 mm) to 200 mils (5 mm), and in one example, about 125 mils. The third resin layer 360 may have a thickness H360 of approximately 1 to 5 mils. In one example, the first resin layer 310 thickness H310 and the second resin layer 340 thickness H340 can have a ratio of greater than 2 and in certain instances can be 1.2 to 8. In one particular example, the first resin layer 310 thickness H310 and the second resin layer 340 thickness H340 can have a ratio of 3. In one example, the first resin layer 310 thickness H310 and the third resin layer 360 thickness H360 can have a ratio of greater than 2 and in certain instances can be 1.2 to 8. In one particular example, the first resin layer 310 thickness H310 and the third resin layer 360 thickness H360 can have a ratio of 3.

In some embodiments, such as the one shown in FIG. 3, the backing layer 370 may be the innermost layer from the floor 3000. The backing layer 370 may have an inner surface 371 configured to be applied to and abut a floor surface 3001. In other examples, and as described for flooring product 100, a film (not shown) may be applied to the inner surface 371 such that the film abuts the floor surface 3001. The backing layer 370 may also have an outer surface 372. Similar to the example illustrated in FIG. 1, the example flooring product 300 illustrated in FIG. 3 may advantageously allow for an outer surface 312 of the first resin layer 310 (i.e., the outermost layer from the floor 3000) to be at a distance H300 that is substantially uniform at substantially all points along the floor surface 3001. In this way, the outer surface 312 of the first resin layer 310 substantially resembles the shape of the floor surface 3001. In other examples, and as described for flooring products 100, 200, a top coat (not shown) may be included on top of the first resin layer 310 such that the top coat is the outermost layer from the floor 3000. The embodiment of the flooring product 300 illustrated in FIG. 3 may provide benefits similar to those described for the flooring product 100 illustrated FIG. 1, and may provide certain enhanced benefits given the addition of a stability layer 350, such as enhanced durability, soundproofing, insulating, and/or dampening qualities. It is also contemplated that other orders of layers, other materials, and/or other thicknesses discussed herein can be used to form the example flooring product layers in this example for optimization of the flooring product.

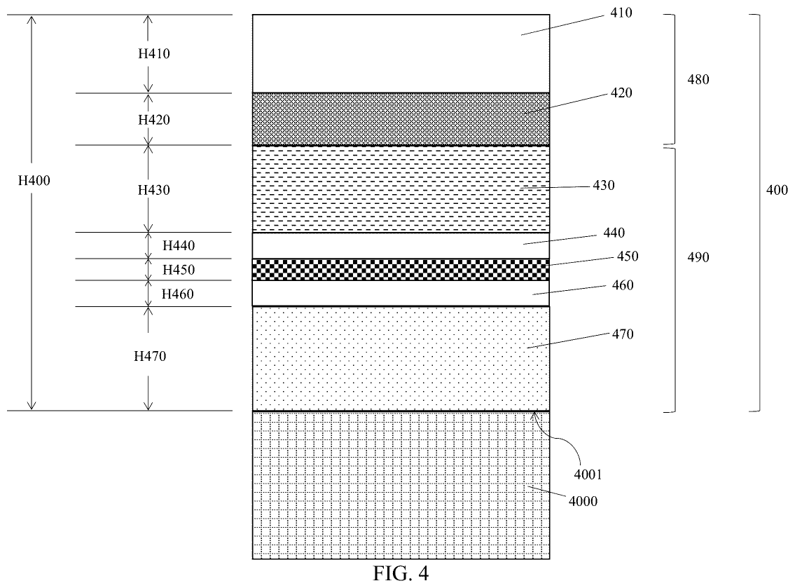

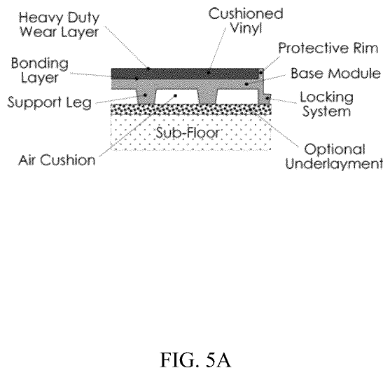

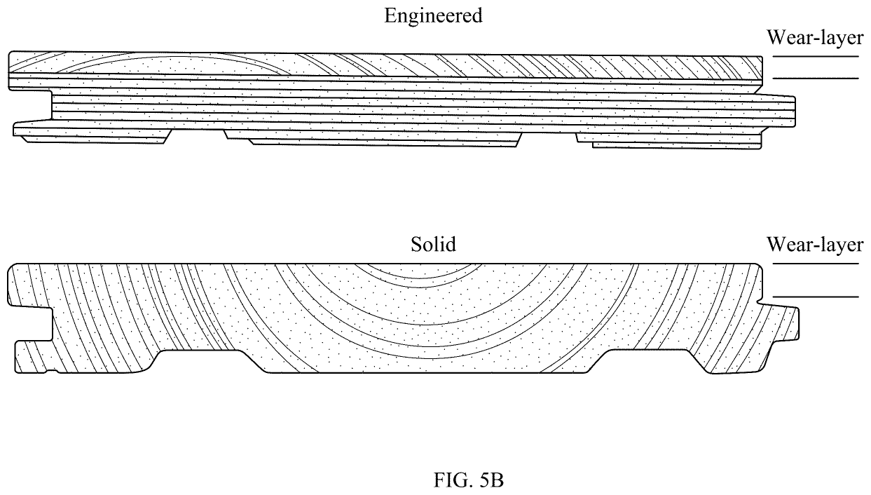

Another example of aspects according to this disclosure is a click lock flooring product 400, illustrated in FIGS. 4-5. Flooring product 400 includes a first resin layer 410 followed by a sheet or an agricultural waste layer 420, a cellulosic layer 430, a second resin layer 440, a stability layer 450, a third resin layer 460, and a backing layer 470. In this example, the first resin layer 410 followed by a sheet or an agricultural waste layer 420 together may form a surface layer 480, and the cellulosic layer 430, second resin layer 440, stability layer 450, third resin layer 460, and backing layer 470 together may form a substrate layer 490. In another example, the sheet or agricultural waste layer 420 may be the innermost layer from the floor 4000. The first resin layer 410, sheet or agricultural waste layer 420, cellulosic layer 430, second resin layer 440, stability layer 450, third resin layer 460, and the backing layer 470 may be comprised of materials as described in relation to the corresponding layers of FIG. 1 above. Further, the backing layer 470 may be made of agricultural waste, minerals such as limestone, plastics such recycled polypropylene, bio-plastics and other materials that exhibit high compression strength and are known to those experienced in the art. The backing layer 470 is configured to be a click lock system according to methods known to those skilled in the art. The thicknesses and/or weights/areal densities of the first resin layer 410, the sheet or agricultural waste layer 420, the cellulosic layer 430, the second resin layer 440, the stability layer 450, and the third resin layer 460 may be similar to those described for the first resin layer 310, the sheet or agricultural waste layer 320, the cellulosic layer 330, the second resin layer 340, the stability layer 350, and the third resin layer 360 of FIG. 3 above. The click lock backing layer 470 may have a thickness H470 of approximately 150 mils to 300 mils, and in one example, about 200 mils.

Several alterations can be made to flooring products 100, 200, 300, 400 to optimize for various properties. For example, it is contemplated that flooring products with orders, or layups, of layers different than those described above for flooring products 100, 200, 300, 400, could be implemented, including flooring products comprising the same layers in a given flooring product 100, 200, 300, 400 but in a different order; flooring products comprising the same layers in a given flooring product 100, 200, 300, 400 in the same order but with different sizes or material combinations (e.g., where the first resin layer comprises a different type of resin than other resin layers); or flooring products with less or more of the same layers in a given flooring product 100, 200, 300, 400. Examples include a flooring product wherein the plurality of layers includes a natural wood release followed by a first resin layer comprising bio-based thermoplastic (5 to 15 mils), a layer comprising flax (100 GSM-300 GSM), and further followed by: a veneer backer with one-side adhesive coating (adhesive up), a second resin layer comprising bio-based thermoplastic (1 to 5 mils), a backing layer comprising 1/16 inch cork; a veneer backer with one-side adhesive coating that uses the resin of the first resin layer, a second resin layer comprising bio-based thermoplastic (1 to 5 mils), a backing layer comprising 1/16 inch cork, a layer comprising parchment, and a breather cloth; a veneer backer with no adhesive coating, a second resin layer comprising bio-based thermoplastic (1 to 5 mils), a backing layer comprising 1/16 inch cork, a third resin layer comprising bio-based thermoplastic (1 to 5 mils), a layer comprising parchment, and a breather cloth; a veneer backer with one-side adhesive coating (adhesive up), a hot melt adhesive, a backing layer comprising 1/16 inch cork, and a layer comprising parchment; a veneer backer with one-side adhesive coating (adhesive up), a second resin layer comprising bio-based thermoplastic (1 to 5 mils), a hot melt adhesive, a backing layer comprising 1/16 inch cork, and a layer comprising parchment; a veneer backer with one-side adhesive coating (adhesive up), a second resin layer comprising bio-based thermoplastic (1 to 5 mils), a backing layer comprising 1/16 inch cork, a layer comprising parchment, and a breather cloth; a veneer backer with one-side adhesive coating (adhesive up), a second resin layer comprising bio-based thermoplastic (1 to 5 mils), optionally a backing layer comprising non-rubber cork or 3/32 inch or 1/16 inch cork, a layer comprising parchment, and a breather cloth; a veneer backer with one-side adhesive coating (adhesive up), a second resin layer comprising bio-based thermoplastic (1 to 5 mils), a layer comprising nonwoven, a third resin layer comprising bio-based thermoplastic, a backing layer comprising cork, a layer comprising parchment, and a breather cloth; a veneer backer with one-side adhesive coating (adhesive up), a second resin layer comprising bio-based thermoplastic, three layers comprising nonwoven, a third resin layer comprising bio-based thermoplastic, a backing layer comprising 3/32 inch cork, a layer comprising parchment, and a breather cloth; a veneer backer with one-side adhesive coating (adhesive down), two layers comprising nonwoven, a second resin layer comprising bio-based thermoplastic, a layer comprising nonwoven, a third resin layer comprising bio-based thermoplastic, a backing layer comprising 3/32 inch cork, a layer comprising parchment, and a breather cloth; a veneer backer with one-side adhesive coating (adhesive up), a second resin layer comprising bio-based thermoplastic (1 to 5 mils), a layer comprising number 40 Kraft cellulosic, a hot melt adhesive, a backing layer comprising cork, a layer comprising parchment, and a breather cloth; a veneer backer with one-side adhesive coating (adhesive up), a layer comprising number 40 Kraft cellulosic, a hot melt adhesive, a backing layer comprising 1/16 inch cork, and a layer comprising parchment; a veneer backer with one-side adhesive coating (adhesive up), a second resin layer comprising bio-based thermoplastic, a layer comprising jute (30 mils), and a layer comprising parchment; a veneer backer with one-side adhesive coating (adhesive up), a second resin layer comprising bio-based thermoplastic (1 to 5 mils), a hot melt adhesive, a backing layer comprising 1/16 inch cork, and a layer comprising parchment; a veneer backer with one-side adhesive coating (adhesive up), a second resin layer comprising bio-based thermoplastic (1 to 5 mils), a hot melt adhesive, a layer comprising jute (30 mils), and a layer comprising parchment; a layer comprising number 70 Kraft cellulosic, a second resin layer comprising bio-based thermoplastic, a layer comprising jute, a third resin layer comprising bio-based thermoplastic, and a layer comprising parchment; a veneer backer with one-side adhesive coating (adhesive down), a layer comprising number 70 Kraft cellulosic, a second resin layer comprising bio-based thermoplastic, a layer comprising jute, a third resin layer comprising bio-based thermoplastic, and a layer comprising parchment; a veneer backer with one-side adhesive coating (adhesive down), a layer comprising number 70 Kraft cellulosic, a second resin layer comprising bio-based thermoplastic, a backing layer comprising cork, and a layer comprising parchment; a veneer backer with one-side adhesive coating (adhesive down), a backing layer comprising cork, a layer comprising jute, a second resin layer comprising bio-based thermoplastic, and a layer comprising parchment; a veneer backer with one-side adhesive coating (adhesive down), a backing layer comprising cork, a layer comprising jute, a second resin layer comprising TPU, and a layer comprising parchment; a veneer backer with one-side adhesive coating (adhesive down), a backing layer comprising rubberized cork, a second resin layer comprising TPU, a layer comprising jute, a third resin layer comprising TPU, and a layer comprising parchment; a veneer backer with one-side adhesive coating (adhesive down), a second resin layer comprising bio-based thermoplastic, a backing layer comprising rubberized cork, and a layer comprising parchment; a veneer backer with one-side adhesive coating (adhesive up), a second resin layer comprising bio-based thermoplastic, optionally a layer comprising nonwoven, optionally a third resin layer comprising bio-based thermoplastic, a layer comprising confetti rubber (2 mm), and a layer comprising parchment; a veneer backer with one-side adhesive coating (adhesive down), a layer comprising nonwoven, a second resin layer comprising TPU, a layer comprising jute, a third resin layer comprising TPU, and a layer comprising parchment; a veneer backer with one-side adhesive coating (adhesive down), a layer comprising number 40 or number 70 Kraft cellulosic, a second resin layer comprising bio-based thermoplastic, a layer comprising nonwoven, a third resin layer comprising TPU, a layer comprising jute, a fourth resin layer comprising TPU, and a layer comprising parchment; a veneer backer with one-side adhesive coating (adhesive up), a second resin layer comprising bio-based thermoplastic, a backing layer comprising rubberized cork, and a layer comprising parchment; a veneer backer with one-side adhesive coating (adhesive up), a second resin layer comprising bio-based thermoplastic (1 to 5mils), a layer comprising nonwoven, a third resin layer comprising bio-based thermoplastic, a backing layer comprising cork or 3/32 inch cork, a layer comprising parchment, and a breather cloth; a veneer backer with one-side adhesive coating (adhesive up), a second resin layer comprising bio-based thermoplastic, a layer comprising confetti rubber, a third resin layer comprising TPU, a layer comprising jute, a fourth resin layer comprising TPU, and a layer comprising parchment; a veneer backer with one-side adhesive coating (adhesive up), a second resin layer comprising bio-based thermoplastic, a layer comprising nonwoven, a third resin layer comprising TPU, a layer comprising jute, a fourth resin layer comprising TPU, and a layer comprising parchment; a veneer backer with one-side adhesive coating (adhesive up), a second resin layer comprising bio-based thermoplastic, a layer comprising natural rubber, and a layer comprising parchment; or a veneer backer with one-side adhesive coating (adhesive up), a second resin layer comprising bio-based thermoplastic (1 to 5 mils), a backing layer comprising 1/16 inch cork, and a layer comprising parchment. Other examples include a flooring product wherein the plurality of layers includes a natural wood release followed by a layer comprising film (1 to 5 mils, primer down), a first resin layer comprising bio-based thermoplastic (9 mils), a layer comprising flax (100-300 GSM,), a veneer backer with one-side adhesive coating (adhesive up), a second resin layer comprising PMMA (6.1 mils or 4.5 mils), a backing layer comprising 3/32 inch cork, a layer comprising parchment, and a polyester breather cloth; and a flooring product wherein the plurality of layers includes a natural wood release followed by a first resin layer comprising bio-based thermoplastic laminated on both sides, a hot melt adhesive (texture side down, 6 mils), a backing layer comprising 1/16 inch cork, and a layer comprising parchment.

The use of a flooring product according to one or more aspects of this disclosure may be detected a number of ways. Exemplary methods of detection may include, for example, microscopy cross-sectional inspection, burn test inspection for plastics identification, manual delamination, and/or product compliance with certain specifications, such as specifications related to composition, flatness, moisture resistance, slip resistance (friction), chemical resistance, aesthetics such as gloss and texture, environmental (VOC), flexibility, consistency of thickness and dimensional stability, and product areal weight.

Further, as discussed, flooring products according to one or more aspects of this disclosure exhibit advantageous qualities, including, for example, durability, such as impact and UV resistance and static load capacity. The durability-related qualities of certain flooring products according to one or more aspects of this disclosure, including in view of the sustainable biomaterials used in the flooring products and the absence of an additional stability layer in certain embodiments.

Durability-related and other tests were conducted on exemplary embodiments of flooring product according to one or more aspects of this disclosure. Tests included small ball, large ball impact resistance testing, and delamination testing. The sample tested was consistent with flooring product 100 illustrated in FIG. 1 and included a first resin layer comprising thermoplastic resin test was conducted in accordance with the EN 13329 standard for flooring, which is incorporated herein fully by reference. For the small ball impact resistance test, the tested sample withstood impacts up to 10 Newtons (N) and thus passed the test. The procedure for the large ball impact resistance test was conducted in accordance with the EN 13329 standard for flooring, which is incorporated herein fully by reference. For the large ball impact resistance test, the tested sample withstood drops of a steel ball weighing 285 grams from a height up to 800 mm and thus passed the test.

Another test was conducted to determine the static load capacity of exemplary embodiments of flooring product according to one or more aspects of this disclosure. The sample tested was the same as the tested sample described above except with a backing layer comprising rubber approximately 118 mils thick. The tested sample withstood a static load of greater than 1.7MPa for longer than 24 hours and thus passed the test.

Flooring products, including those disclosed herein, may be manufactured using many methods. In one example, resin layers are applied as the top and bottom layer with a sheet or an agricultural waste layer and a cellulosic layer in between the resin layers, where the sheet or agricultural waste layer abuts the first resin layer and the cellulosic layer abuts the second resin layer. A flexible backing layer may also be applied underneath the second resin layer. The resin layers may be oriented in various orientations, such as, for example biaxially, or may be non-oriented. The process may be conducted at a constant pressure in the range of about 0.1 psi to about 150 psi and at a temperature of greater than about 150° F. The process may have a run rate in the range of about 0.25 m/minute to about 25 m/minute. Depending on the size of the flooring product, the process may have a total run time in the range of about 30 seconds to about 60 minutes. The process may also be conducted in separate stages. For example, certain layers may be processed, and then additional layers (e.g., adhesive layers, additional fiber layers, and/or cellulosic layers) may be added and processed separately. The big variance in processing time is due to the manufacturing equipment and process. For instance an industrial roll-to-roll process may be able to have much faster processing time than a static press, though the latter may be able to process many sheets at once. In addition, those familiar in the art may also use resin that cures at room temperature such as thermosetting bio-epoxy, lignan, or linseed oil.

The resin layers used in the exemplary process may be comprised of materials as described in relation to the first resin layer 210 and the second resin layer 240 of FIG. 2 above and may be comprised of polylactic acid (PLA). The sheet or agricultural waste layer used in the exemplary process may be comprised of materials as described in relation to the sheet or agricultural waste layer 220 of FIG. 2 above and may be comprised of flax. The cellulosic layer used in the exemplary process may be comprised of materials as described in relation to the cellulosic layer 230 of FIG. 2 above and may be comprised of backing cellulosic material. The flexible backing layer used in the exemplary process may be comprised of materials as described in relation to the backing layer 250 of FIG. 2 above and may be comprised of rubber. In one exemplary embodiment of the process, the first resin layer may have a thickness of approximately 9 mils, the second resin layer may have a thickness of approximately 1 to 5 mils, the cellulosic layer may have a thickness of approximately 10 mils, the flexible backing layer may have a thickness of approximately 118 mils, and the sheet or agricultural waste layer may have a weight/areal density of approximately 105 GSM. In other embodiments, such as embodiments where a flooring product of a different thickness is desired, the number of layers, such as resin layers, may be increased or decreased and, further, the thickness and/or weight/areal density of each layer may be increased or decreased. For example, the second resin layer may have a thickness of approximately 1 to 5 mils, and a third resin layer with an approximate thickness of 1 to 5 mils may be used such that the second resin layer and the third resin layer are on the top and bottom of the cellulosic layer.

In the above examples, red list chemicals may be avoided. Thermoset chemistry is a known carcinogen as per California prop 65 and may be avoided. Also, wood may be avoided, assisting in efforts to mitigate deforestation. Further, applying a secondary finishing process such as painting, for example, to reduce moisture absorption by the layers of the flooring product, may in certain examples be avoided. This may help in certain instances to reduce the labor and expense in the finishing process and avoid finishing chemicals that have high VOCs (thus designated as carcinogenic as per California proposition 65). Additionally, non-VOC solutions are not sufficiently abrasion or moisture resistant meaning that VOCs are difficult to avoid in secondary finishing processes.

The example flooring products and manufacturing processes discussed herein use bio-based materials, have low VOC content, exhibit advantageous durability-related qualities, are environmentally sustainable, are easy to install, are cost competitive, and are aesthetically appealing. The example flooring products and manufacturing processes discussed herein can be tailored to produce a wide variety of aesthetic (e.g., wood-esque) products without significantly compromising bio composition, low VOC content, and durability, including in some examples without the need for an additional built-in layer dedicated to stability.

While the invention has been described with respect to specific examples including presently preferred modes of carrying out the invention, those skilled in the art will appreciate that there are numerous variations and permutations of the above described systems and methods. Thus, the spirit and scope of the invention should be construed broadly as set forth in the appended claims.

For the avoidance of doubt, the present application includes at least the subject matter described in the following numbered Clauses:

Clause 1. A flooring product, the flooring product comprising:
an outer surface and an inner surface, a plurality of layers, the plurality of layers comprising:
a first resin layer comprising a first resin layer thickness and a first resin layer inner surface, wherein the first resin layer inner surface is located at a first resin layer distance from the inner surface;
a sheet comprising natural fibers comprising a sheet thickness and a sheet inner surface, wherein the sheet inner surface is located at a sheet distance from the inner surface, and wherein the sheet distance is less than the first resin layer distance;
a second resin layer comprising a second resin layer thickness and a second resin layer inner surface, wherein the second resin layer inner surface is located at a second resin layer distance from the inner surface, and wherein the second resin layer distance is less than the sheet layer distance;
a cellulosic layer comprising a cellulosic layer thickness and a cellulosic layer inner surface, wherein the cellulosic layer inner surface is located at a cellulosic layer distance from the inner surface, and wherein the cellulosic layer distance is less than the second resin layer distance;
a third resin layer comprising a third resin layer thickness and a third resin layer inner surface, wherein the third resin layer inner surface is located at a third resin layer distance from the inner surface, and wherein the third resin layer distance is less than the cellulosic layer distance;
wherein the flooring product is configured to be rollable.

Clause 2. The flooring product of Clause 1, wherein the natural fibers are formed from agricultural waste.

Clause 3. The flooring product of any of the Clauses 1 to 2 further comprising an additional stability layer, wherein the additional stability layer comprises tempered hardboard.

Clause 4. The flooring product of any of the Clauses 1 to 3, wherein the additional stability layer further comprises one of a cork or a rubber blend and combinations thereof.

Clause 5. The flooring product of any of the Clauses 1 to 4 further comprising an adhesive layer made from resin.

Clause 6. The flooring product of any of the Clauses 1 to 5 further comprising an adhesive layer made partially or completely from bio-based feedstocks.

Clause 7. The flooring product of any of the Clauses 1 to 6, wherein the flooring product comprises a total thickness, and wherein the total thickness is less than 2.6 mm.

Clause 8. The flooring product of any of the Clauses 1 to 7, wherein an estimated global warming potential is between 0.25 to 1.5 kgCO2eq/kg.

Clause 9. The flooring product of any of the Clauses 1 to 8, wherein an estimated global warming potential is about −0.128 kgCO2eq/kg.

Clause 10. The flooring product of any of the Clauses 1 to 9, wherein the plurality of layers is configured to stabilize the flooring product to withstand a static load limit of greater than 1.2 MPa.

Clause 11. The flooring product of any of the Clauses 1 to 10, wherein the flooring product has a volatile organic compounds content of less than 0.22 mg/m3.

Clause 12. The flooring product of any of the Clauses 1 to 11, wherein the flooring product provides a wood-esque property.

Clause 13. The flooring product of any of the Clauses 1 to 12, wherein the flooring product is able to be manufactured via a static and continuous heated and pressurized process in a single operation or in multiple operations.

Clause 14. The flooring product of any of the Clauses 1 to 13, wherein the flooring product is one of a plank, a panel, or tile.

Clause 15. The flooring product of any of the Clauses 1 to 14, wherein the agricultural waste comprises one of flax, hemp, sisal, ramie, abaca, jute, agave, nettle, covercress stalk, soybean meal, grape vines, mulch, general organic matter, or wood fiber.

Clause 16. The flooring product of any of the Clauses 1 to 15, wherein the flooring product comprises a plurality of click lock tiles.

Clause 17. The flooring product of any of the Clauses 1 to 16, wherein the flooring product is configured to withstand small ball impact resistance tests with impacts of about 10 Newtons (N).

Clause 18. The flooring product of any of the Clauses 1 to 17, wherein the flooring product is configured to withstand large ball impact resistance tests with drops from a height of about 800 mm.

Clause 19. The flooring product of any of the Clauses 1 to 18 further comprising an additional stability layer, wherein the additional stability layer comprises tempered hardboard.

Clause 20. The flooring product of any of the Clauses 1 to 19, wherein the flooring product provides a wood-esque property.

Clause 21. A method of producing a composite for applying to a floor, the method comprising:
preparing a plurality of layers, comprising:
preparing a first resin layer comprising a bioplastic and a first resin layer thickness;
preparing an agricultural waste layer comprising an agricultural waste layer thickness;
preparing a backing layer comprising a backing layer thickness;
preparing a second resin layer comprising a bioplastic and a second resin layer thickness, wherein the second resin layer thickness is less than the first resin layer thickness;
preparing a flexible backing layer comprising a flexible backing layer thickness; and
at a constant pressure of from about 0.1 psi to about 300 psi and at a temperature greater than about 150° F.:
   applying the first resin layer to a top side of the agricultural waste layer;
   applying the backing layer to a bottom side of the agricultural waste layer;
   applying the second resin layer to a bottom side of the backing layer; and
   applying the flexible backing layer to a bottom side of the second resin layer.

Clause 22. The method of Clause 21, wherein the flexible backing layer is prepared using recycled waste.

Clause 23. A flooring product, the flooring product comprising:
an outer surface and an inner surface, a plurality of layers, the plurality of layers comprising:
a first resin layer comprising a first resin layer thickness and a first resin layer inner surface, wherein the first resin layer inner surface is located at a first resin layer distance from the inner surface;
a sheet comprising a plurality of natural fiber layers, a sheet thickness, and a sheet inner surface, wherein the sheet inner surface is located at a sheet distance from the inner surface, wherein the sheet distance is less than the first resin layer distance, and wherein the plurality of natural fiber layers comprise a first natural fiber layer running 90 degrees to a second natural fiber layer;
a second resin layer comprising a second resin layer thickness and a second resin layer inner surface, wherein the second resin layer inner surface is located at a second resin layer distance from the inner surface, and wherein the second resin layer distance is less than the sheet layer distance;
a cellulosic layer comprising a cellulosic layer thickness and a cellulosic layer inner surface, wherein the cellulosic layer inner surface is located at a cellulosic layer distance from the inner surface, and wherein the backing layer distance is less than the second resin layer distance;
a third resin layer comprising a third resin layer thickness and a third resin layer inner surface, wherein the third resin layer inner surface is located at a third resin layer distance from the inner surface, and wherein the third resin layer distance is less than the backing layer distance;
wherein the flooring product is configured to be rollable.

Clause 24. The flooring product of Clause 23, wherein the plurality of natural fiber layers are formed from agricultural waste.

1. A flooring product, the flooring product comprising:
an outer surface and an inner surface, a plurality of layers, the plurality of layers comprising:
a first resin layer comprising a first resin layer thickness and a first resin layer inner surface, wherein the first resin layer inner surface is located at a first resin layer distance from the inner surface;
a sheet comprising natural fibers comprising a sheet thickness and a sheet inner surface, wherein the sheet inner surface is located at a sheet distance from the inner surface, and wherein the sheet distance is less than the first resin layer distance;
a second resin layer comprising a second resin layer thickness and a second resin layer inner surface, wherein the second resin layer inner surface is located at a second resin layer distance from the inner surface, and wherein the second resin layer distance is less than the sheet layer distance;
a cellulosic layer comprising a cellulosic layer thickness and a cellulosic layer inner surface, wherein the cellulosic layer inner surface is located at a cellulosic layer distance from the inner surface, and wherein the cellulosic layer distance is less than the second resin layer distance;
a third resin layer comprising a third resin layer thickness and a third resin layer inner surface, wherein the third resin layer inner surface is located at a third resin layer distance from the inner surface, and wherein the third resin layer distance is less than the cellulosic layer distance;
wherein the flooring product is configured to be rollable.

2. The flooring product of claim 1, wherein the natural fibers are formed from agricultural waste.

3. The flooring product of claim 1 further comprising an additional stability layer, wherein the additional stability layer comprises tempered hardboard.

4. The flooring product of claim 3, wherein the additional stability layer further comprises one of a cork or a rubber blend and combinations thereof.

5. The flooring product of claim 1 further comprising an adhesive layer made from resin.

6. The flooring product of claim 1 further comprising an adhesive layer made partially or completely from bio-based feedstocks.

7. The flooring product of claim 1, wherein the flooring product comprises a total thickness, and wherein the total thickness is less than 2.6 mm.

8. The flooring product of claim 1, wherein an estimated global warming potential is between 0.25 to 1.5 kgCO2eq/kg.

9. The flooring product of claim 1, wherein an estimated global warming potential is about −0.128 kgCO2eq/kg.

10. The flooring product of claim 1, wherein the plurality of layers is configured to stabilize the flooring product to withstand a static load limit of greater than 1.2 MPa.

11. The flooring product of claim 1, wherein the flooring product has a volatile organic compounds content of less than 0.22 mg/m3.

12. The flooring product of claim 1, wherein the flooring product provides a wood-esque property.

13. The flooring product of claim 1, wherein the flooring product is able to be manufactured via a static and continuous heated and pressurized process in a single operation or in multiple operations.

14. The flooring product of claim 1, wherein the flooring product is one of a plank, a panel, or tile.

15. The flooring product of claim 1, wherein the agricultural waste comprises one of flax, hemp, sisal, ramie, abaca, jute, agave, nettle, covercress stalk, soybean meal, grape vines, mulch, general organic matter, or wood fiber.

16. The flooring product of claim 1, wherein the flooring product comprises a plurality of click lock tiles.

17. The flooring product of claim 1, wherein the flooring product is configured to withstand small ball impact resistance tests with impacts of about 10 Newtons (N).

18. The flooring product of claim 1, wherein the flooring product is configured to withstand large ball impact resistance tests with drops from a height of about 800 mm.

19. The flooring product of claim 1 further comprising an additional stability layer, wherein the additional stability layer comprises tempered hardboard.

20. The flooring product of claim 19, wherein the flooring product provides a wood-esque property.

21. A method of producing a composite for applying to a floor, the method comprising:
preparing a plurality of layers, comprising:
preparing a first resin layer comprising a bioplastic and a first resin layer thickness;
preparing an agricultural waste layer comprising an agricultural waste layer thickness;
preparing a backing layer comprising a backing layer thickness;
preparing a second resin layer comprising a bioplastic and a second resin layer thickness, wherein the second resin layer thickness is less than the first resin layer thickness;
preparing a flexible backing layer comprising a flexible backing layer thickness; and
at a constant pressure of from about 0.1 psi to about 300 psi and at a temperature greater than about 150° F.:
applying the first resin layer to a top side of the agricultural waste layer;
applying the backing layer to a bottom side of the agricultural waste layer;
applying the second resin layer to a bottom side of the backing layer; and
applying the flexible backing layer to a bottom side of the second resin layer.

22. The method of claim 21, wherein the flexible backing layer is prepared using recycled waste.

23. A flooring product, the flooring product comprising:
an outer surface and an inner surface, a plurality of layers, the plurality of layers comprising:
a first resin layer comprising a first resin layer thickness and a first resin layer inner surface, wherein the first resin layer inner surface is located at a first resin layer distance from the inner surface;
a sheet comprising a plurality of natural fiber layers, a sheet thickness, and a sheet inner surface, wherein the sheet inner surface is located at a sheet distance from the inner surface, wherein the sheet distance is less than the first resin layer distance, and wherein the plurality of natural fiber layers comprise a first natural fiber layer running 90 degrees to a second natural fiber layer;
a second resin layer comprising a second resin layer thickness and a second resin layer inner surface, wherein the second resin layer inner surface is located at a second resin layer distance from the inner surface, and wherein the second resin layer distance is less than the sheet layer distance;
a cellulosic layer comprising a cellulosic layer thickness and a cellulosic layer inner surface, wherein the cellulosic layer inner surface is located at a cellulosic layer distance from the inner surface, and wherein the backing layer distance is less than the second resin layer distance;
a third resin layer comprising a third resin layer thickness and a third resin layer inner surface, wherein the third resin layer inner surface is located at a third resin layer distance from the inner surface, and wherein the third resin layer distance is less than the backing layer distance;
wherein the flooring product is configured to be rollable.

24. The flooring product of claim 23, wherein the plurality of natural fiber layers are formed from agricultural waste.
